(19) United States
(12) Patent Application Publication
(10) Pub. No.: US 2014/0166569 A1
(43) Pub. Date: Jun. 19, 2014

(54) WATER FILTER

(71) Applicant: AQUAPRO INDUSTRIAL CO., LTD., Taipei City (TW)

(72) Inventor: Wen-Fen Chow, TAIPEI CITY (TW)

(73) Assignee: AQUAPRO INDUSTRIAL CO., LTD., TAIPEI CITY (TW)

(21) Appl. No.: 13/714,054

(22) Filed: Dec. 13, 2012

(51) Int. Cl. B01D 29/15

(52) U.S. Cl. CPC B01D 29/15
USPC 210/440

(57) ABSTRACT

A water filter has a filter body, a filtering tube and an assembling cover. The engaging portion of the filtering tube securely engages with the water channel of the assembling cover, and the engaging disk of the filtering tube securely engages with the engaging circular rib of the filtering space, such that the filtering tube is securely limited and positioned between the filter body and the assembling cover; furthermore, the filtering tube, the filter body and the assembling cover respectively engage with each other and are combined together by the welding process, to completely prevent the filtering tube from deforming and misplacing.

### BACKGROUND OF THE INVENTION

1. Field of the Invention

The present invention relates to a water filter, and more particularly to a water filter which can prevent water from being unfiltered.

2. Description of the Related Art

Currently, a typical water filter, as shown in FIG. 5, comprises a filter body 40, a cover 50 and a filtering member 60. The filter body 40 is hollow and has a filtering space 41 and an opening. The cover 50 is assembled onto the opening of the filter body 40, the cover 50 is provided with an assembling portion 51, an filtering tube 52 and a water channel 521. Furthermore, the assembling portion 51 has an inlet aperture 511 corresponding to the outputting tube 52. The filtering member 60 is placed in the filter body 40 and the cover 50, the filtering member 60 is provided with a tapered tube 61 which is inserted into the water channel 521 of the cover 50. Moreover, as shown in FIG. 6, when water enters from the inlet aperture 511 of the cover 50 into the filtering space 41 of the filter body 40, passes through the filtering member 60, and then from the tube 61 of the filtering member 60 leaves from the water channel 521. However, during the flowing process, a water pressure might cause the filtering member 60 to move or deform. In addition, the tapered tube 61 of the filtering member 60 is placed in the water channel 51 of the cover 50, when the filtering member 60 moves or deforms, a gap might be created between the tapered tube 61 and the water channel 51 which can bring unfiltered into the water channel 51.

Therefore, it is desirable to provide a water filter to mitigate and/or obviate the aforementioned problems.

### SUMMARY OF THE INVENTION

An objective of the present invention is to provide shock absorbers for a bicycle with a light weight and simple structure.

In order to achieve the above mentioned objective, a water filter has a filter body, a filtering tube and an assembling cover. The filter body is hollow and has a filtering space and an opening at an upper end. A center area of a bottom of the filtering space is provided with an engaging circular rib. The filtering tube has a plurality of through apertures on a sidewall arranged in a predetermined layout. The filtering tube has a filtering cotton member covering onto the through apertures. Furthermore, an engaging disk is provided at a bottom of the filtering tube. An engaging portion is provided at a center area of a top of the filtering tube. The assembling cover is provided with an assembling portion at a top surface, and the assembling portion has an outputting tube with an internal axial water channel at a center area. The assembling portion further has an inlet aperture at an upper surface corresponding to the outputting tube. The water channel of the assembling cover engages with the engaging portion of the filtering tube and the assembling cover securely covers the opening of the filter body by a welding process. A bottom end of the engaging disk is provide with a second engaging protrusion for engaging with the engaging circular rib of the filter body when the filtering tube is installed in the filter body. The engaging disk of the filtering tube is secured onto with the filter body by a welding process, such that the filtering tube, the engaging disk and the filter body are respectively welded together, and last the assembling cover is secured onto the opening of the filter body by a welding process.

With the above-mentioned structure, following benefit can be obtained:

the engaging portion of the filtering tube securely engages with the water channel of the assembling cover, and the engaging disk of the filtering tube securely engages with the engaging circular rib of the filtering space, such that the filtering tube is securely limited and positioned between the filter body and the assembling cover; furthermore, the filtering tube, the filter body and the assembling cover respectively engage with each other and are combined together by the welding process, to completely prevent the filtering tube from deforming and misplacing.

Other objects, advantages, and novel features of the invention will become more apparent from the following detailed description when taken in conjunction with the accompanying drawings.

### BRIEF DESCRIPTION OF THE DRAWINGS

FIG. 1 is a perspective drawing of an embodiment of the present invention.

FIG. 2 is an exploded drawing of the embodiment of the present invention.

FIG. 3 is a cross-sectional drawing of the embodiment of the present invention.

FIG. 4 is a status drawing of the assembly of the embodiment of the present invention.

FIG. 5 is a schematic drawing of a conventional water filter.

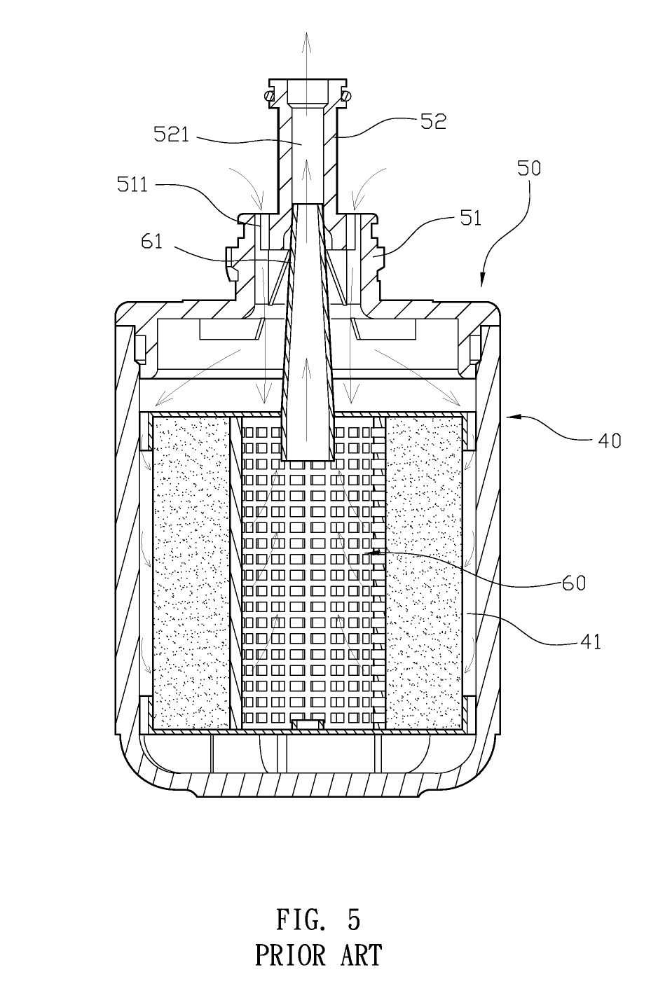

FIG. 6 is another schematic drawing of a conventional water filter.

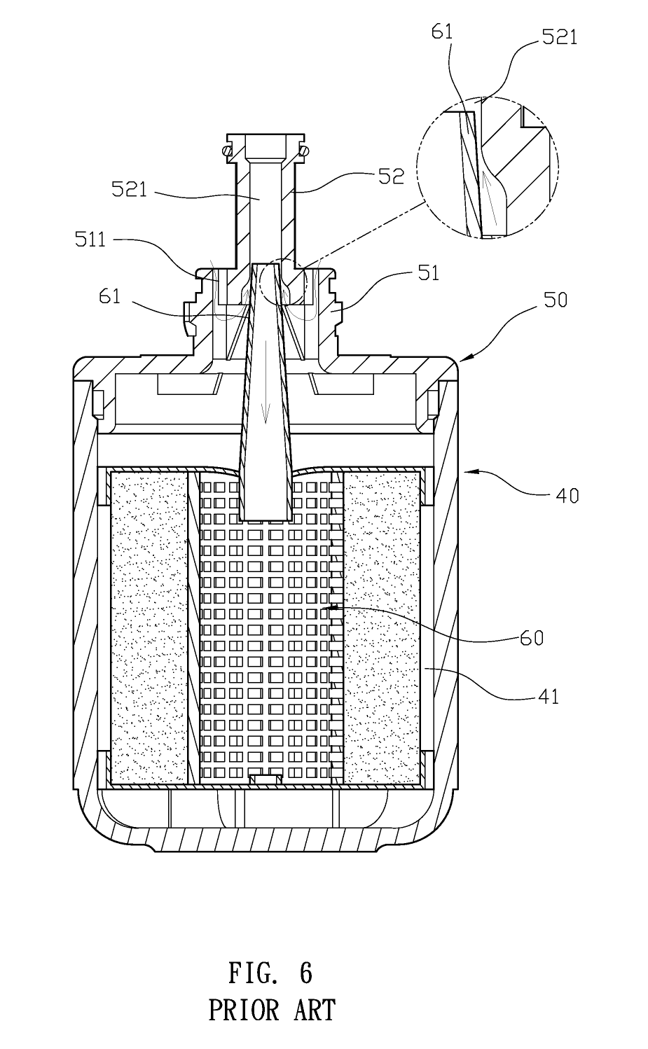

### DETAILED DESCRIPTION OF THE PREFERRED EMBODIMENT

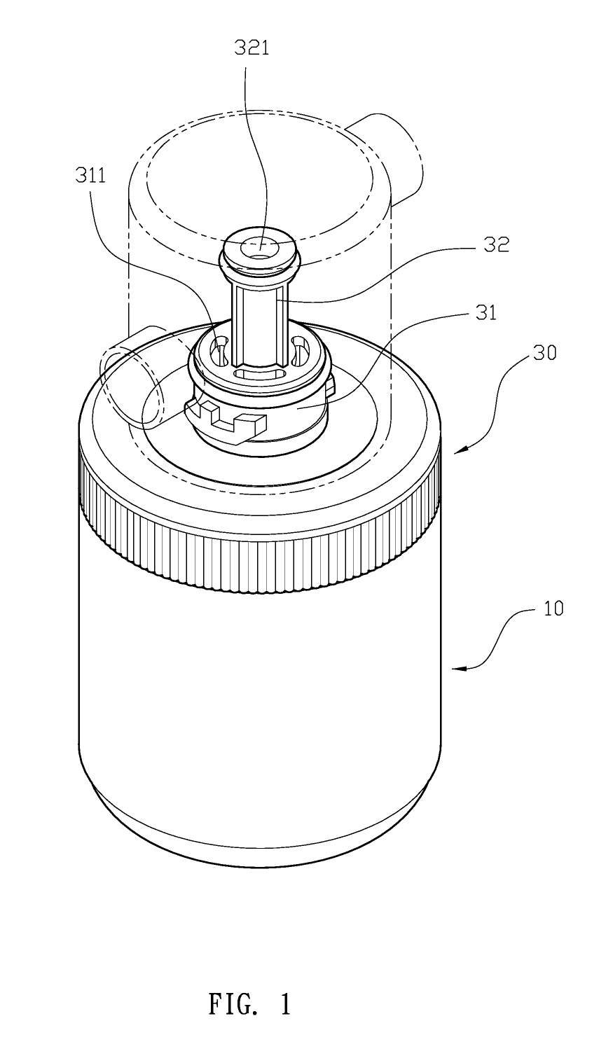

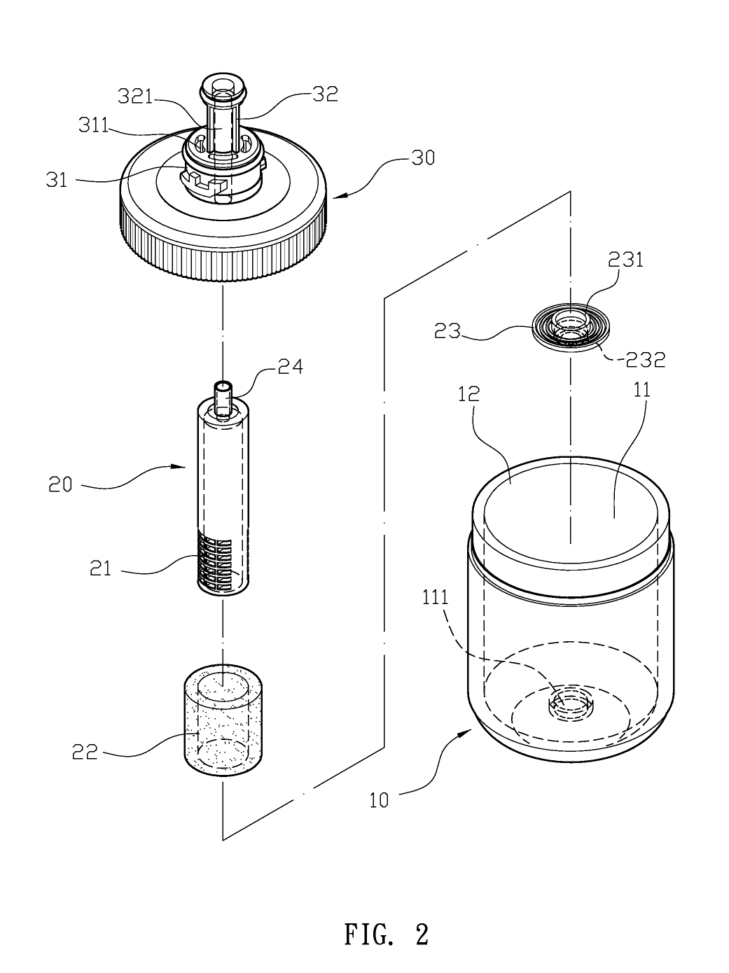

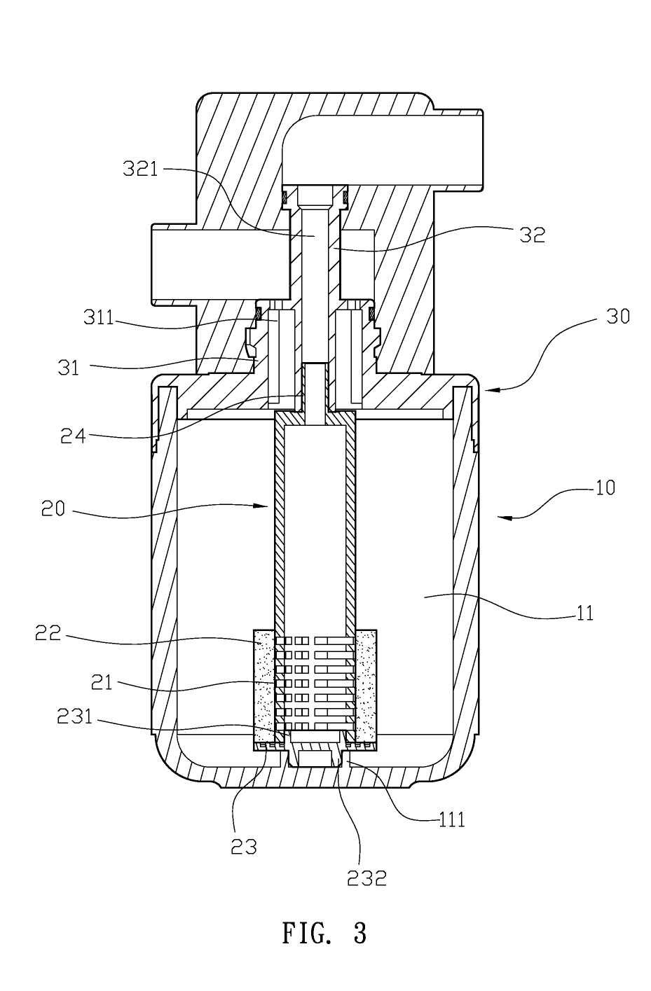

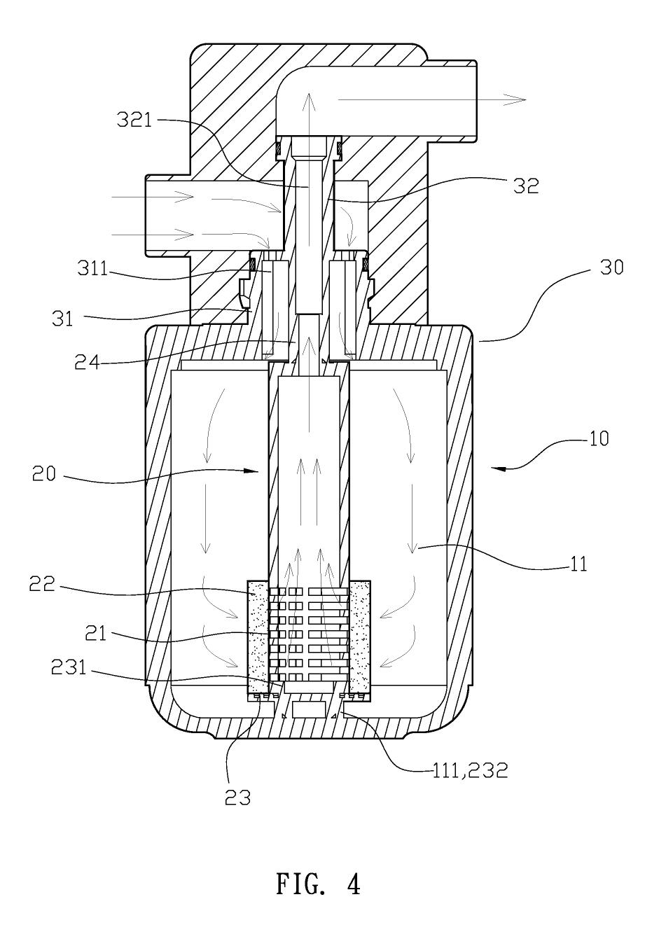

Please refer to FIG. 1 to FIG. 4 together. A water filter comprises a filter body 10, a filtering tube 20 and an assembling cover 30. The filter body 10 is hollow and has a filtering space 11 and an opening 12 at an upper end. A center area of a bottom of the filtering space 11 is provided with an engaging circular rib 111. The filtering tube 20 has a plurality of through apertures 21 on a sidewall arranged in a predetermined layout. The filtering tube 20 has a filtering cotton member 22 covering onto the through apertures 21. Furthermore, an engaging disk 23 is provided at a bottom of the filtering tube 20, and an upper end of the engaging disk 23 is provided with a first engaging protrusion 231 for being inserted into the filtering tube 20. An engaging portion 24 is provided at a center area of a top of the filtering tube 20. The assembling cover 30 is provided with an assembling portion 31 at a top surface, and the assembling portion 31 has an outputting tube 32 with an internal axial water channel 321 at a center area. The assembling portion 31 further has an inlet aperture 311 at an upper surface corresponding to the outputting tube 32. The water channel 321 of the assembling cover 30 engages with the engaging portion 24 of the filtering tube 20 and the assembling cover 30 securely covers the opening 12 of the filter body 10 by a welding process. A bottom end of the engaging disk 23 is provide with a second engaging protrusion 232 for engaging with the engaging circular rib 111 of the filter body 10 when the filtering tube 20 is installed in the filter body 10. The engaging disk 23 of the filtering tube 20 is secured onto with the filter body 10 by a welding process, such that the filtering tube 20, the engaging disk 23 and the filter body 10 are respectively welded together, and last the assembling cover 30 is secured onto the opening 12 of the filter body 10 by a welding process. Please refer to FIG. 4 again. Other filtering material can be added between the filtering space 11 of the filter body 10 and the filtering tube 20. the assembling portion 31 and the outputting tube 32 of the assembling cover 30 are used for assembling with other external apparatus and a water supply, and the inlet aperture 311 of the assembling portion 31 and the water channel 321 of the outputting tube 32 are respectively connected to different outlet ends. Accordingly, when a user turn on the water supply, the unfiltered water enters from the inlet aperture 311 into the filtering space 11 of the filter body 10, passes through other filtering material and the filtering cotton member 22 of the filtering tube 20, via the through apertures 21 into the filtering tube 20, and exits from the water channel 321 of the outputting tube 32.

Furthermore, the engaging portion 24 of the filtering tube 20 securely engages with the water channel 321 of the assembling cover 30. Therefore, when the filtered water flows from the through aperture 21 into the filtering tube 20 and exits from the water channel 321 of the outputting tube 32, there is no gap between the engaging portion 24 and the water channel 321, the filtering tube 20 is not suffered any flowing pressure, and the engaging portion 24 of the filtering tube 20 is free from deforming or misplaced, which can completely prevent the unfiltered water to enter into the water channel 321.

Moreover, the engaging disk 23 of the filtering tube 20 securely engages with the engaging circular rib 111 of the filtering space 11, such that the first engaging protrusion 231 and the second engaging protrusion 232 of the engaging disk 23 respectively engages with the filtering tube 20 and the engaging circular rib 111 to combine the filtering tube 20 and the filter body 10 together. Accordingly, the filtering tube 20 is free from misplacement cause by water flowing pressure.

With the above-mentioned structure, following benefit can be obtained: the engaging portion 24 of the filtering tube 20 securely engages with the water channel 321 of the assembling cover 30, and the engaging disk 23 of the filtering tube 20 securely engages with the engaging circular rib 111 of the filtering space 11, such that the filtering tube 20 is securely limited and positioned between the filter body 10 and the assembling cover 30; furthermore, the filtering tube 20, the filter body 10 and the assembling cover 30 respectively engage with each other and are combined together by the welding process, to completely prevent the filtering tube 20 from deforming and misplacing.

Although the present invention has been explained in relation to its preferred embodiment, it is to be understood that many other possible modifications and variations can be made without departing from the spirit and scope of the invention as hereinafter claimed.

What is claimed is:

1. A water filter comprising:
a filter body configured to provide a filtering space and an opening, a center area of a bottom of the filtering space provided with a circular engaging rib;
a filtering tube having a plurality of through apertures on a sidewall thereof, a filtering member disposed around the through apertures, and an engaging portion provided at a center area of a top of the filtering tube;
an engaging disk provided at a bottom of the filtering tube, the engaging disk comprising sin a bottom end engaged with the upper engaging rib and an upper end engaged with the bottom of the filtering tube; and
an assembling cover provided with an assembling portion at a top surface thereof, the assembling portion having an outputting tube with an internal axial water channel at a center area, the assembling portion further having an inlet aperture at an upper surface corresponding to the outputting tube, the water channel of the assembling cover engaging with the engaging portion of the filtering tube and the assembling cover covering the opening of the filter body.

2. The water filter as claimed in claim 1, wherein the upper end of the engaging disk is provided with a first engaging protrusion for being inserted into the filtering tube, the bottom end of the engaging disk is provide with a second engaging protrusion for engaging with the engaging circular rib of the filter body when the filtering tube is installed in the filter body.

3. The water filter as claimed in claim 1, wherein when the engaging disk of the filtering tube engages with the filter body, the filtering tube, the engaging disk and the filter body all securely connected together.
